(19) United States
(12) Patent Application Publication
(10) Pub. No.: US 2018/0174618 A1
(43) Pub. Date: Jun. 21, 2018

(54) HIGHLIGHT EDITOR

(71) Applicant: Forbidden Technologies plc, Wimbledon, London (GB)

(72) Inventors: Jens Wikholm, Middlesex (GB); Aziz Musa, Surrey (GB); Stephen Streater, London (GB)

(21) Appl. No.: 15/580,544

(22) PCT Filed: Jun. 7, 2016
(86) PCT No.: PCT/GB2016/051676

§ 371 Date: Dec. 7, 2017

(30) Foreign Application Priority Data
Jun. 8, 2015 (GB) 1509890.8

(51) Int. Cl. G11B 27/036; G11B 27/00; G11B 27/34; G11B 27/10; G06F 3/0484

(52) U.S. Cl. CPC G11B 27/036; G11B 27/005; G06F 3/0484; G11B 27/102; G11B 27/34

(57) ABSTRACT

A system for editing at least one media clip comprising highlighting means to highlight a selected portion of the media clip, recording means to record data in respect of said highlighted portion, and storage means to store said recorded data.

The present invention relates to editing various source media to produce a desired end product.

### BACKGROUND

Electronic recording of events in terms of what can been seen and heard has a long history. With this ability to capture events electronically comes the desire to craft and adapt the recordings to produce a final product to reflect the vision and desire of the recorder or target audience of the recording.

Historically the recordings are adapted by using an electronic editing device, which provides one view in which the source material may be viewed and edited, and a separate view in which the edited material can be further refined. The electronic editing device provides for the source and edited material to be viewed in its native form, and also provides for the user to ‘zoom in’ on selected portions of the recording, or, in some electronic editing devices, to be viewed frame by frame. This is commonly used for, and works effectively with, arrangements in which large volumes of content need to be processed to provide a very small final product, i.e. where there are large shooting ratios.

As the numbers of recording devices increase and diversify, and become accessible to more users, there is a need for simpler and more straightforward methods and devices for editing electronically recorded content. In particular media editing such as, for example, video editing, is increasingly relevant in respect of small amounts of content. For example, amateur individuals—meaning individuals with no experience or training in electronic editing—may record content on a variety of recording devices such as mobile phones, tablets, or other devices, on occasions that have a personal significance for them, for example at a party, wedding or family gathering. Current methods of editing content are complex and labour intensive, and unsuitable and inaccessible for such users.

The present invention seeks to overcome these difficulties by providing a media editing mechanism that is simple and accessible for all users.

In its broadest aspect, the present invention provides a system for editing at least one media clip comprising highlighting means to highlight a selected portion of the media clip, recording means to record data in respect of said highlighted portion, and storage means to store said recorded data.

Preferably the recorded data is recorded in a timeline.

Preferably highlighting indicates a start position of a selection and an end position of a selection.

Preferably the start and end positions represent respective times of the start and of the end of the media clip selection.

Preferably the action of moving a pointer over a clip is operable to play the media near to a position or time represented by the position of the pointer.

Preferably the start and end times relate to said timeline on which the highlighted portion is placed.

Preferably the start and end positions represent respective pixel positions of the start and of the end of the media clip selection.

Preferably the start and end pixel positions relate to the source clip or preview window from which the highlighted portion is selected.

Preferably the system further comprises means to join said stored portion to other stored portions to form a compilation media clip.

Preferably the, or each, highlighted portion is allocated a colour.

Preferably the highlighted portion is tinted the allocated colour.

Preferably the colour allocated to each highlighted portion is different from the colours allocated to other ones of respective highlighted portions.

Preferably the tint is provided to the respective selected portion in the timeline.

Preferably the tint is provided to the source clip of the selected portion.

Preferably an order of selected clips in a compilation clip may be reordered

Preferably the timeline has a predetermined size.

Preferably on highlighting, an end portion of said highlighted portion is played back.

Preferably the highlighting means comprises a pointer.

Preferably the pointer may be moved over a source clip at a speed dependent on a user speed selection.

Preferably the pointer is a mouse.

Preferably the said mouse provides for the highlighted portion to be selected by pointing and clicking.

Preferably the system further comprises generating a series of instructions to operate on source media to generate a timeline of selected media clips.

Preferably the series of instructions comprise an Edit Decision List.

Preferably the Edit Decision List is adapted for interpretation to provide the timeline of selected media clips.

### BRIEF DESCRIPTION OF THE DRAWINGS

The invention will now be described by way of example with reference to the accompanying drawings in which:

FIG. 1 is an example of prior art editing arrangements,

FIG. 2 shows a media recording or clip to be edited,

FIG. 3(a) shows a the video clip in accordance with FIG. 2,

FIG. 3(b) shows the video clip of FIG. 3(a) with a representative of a highlighter editor mechanism,

FIG. 4(a) shows several video clips in accordance with FIGS. 2 and 3(a),

FIG. 4(b) shows the video clips of FIG. 4(a) with selected portions of each clip highlighted in accordance with the present invention,

FIG. 4(c) shows the selected portions of FIG. 4(b) combined to form a final clip,

FIG. 5 shows several preview windows, with source clips and a preview window relating to a particular preview window from which a portion has been highlighted for selection,

FIG. 6(a)-(c) show a video clip with a highlighted portion in accordance with

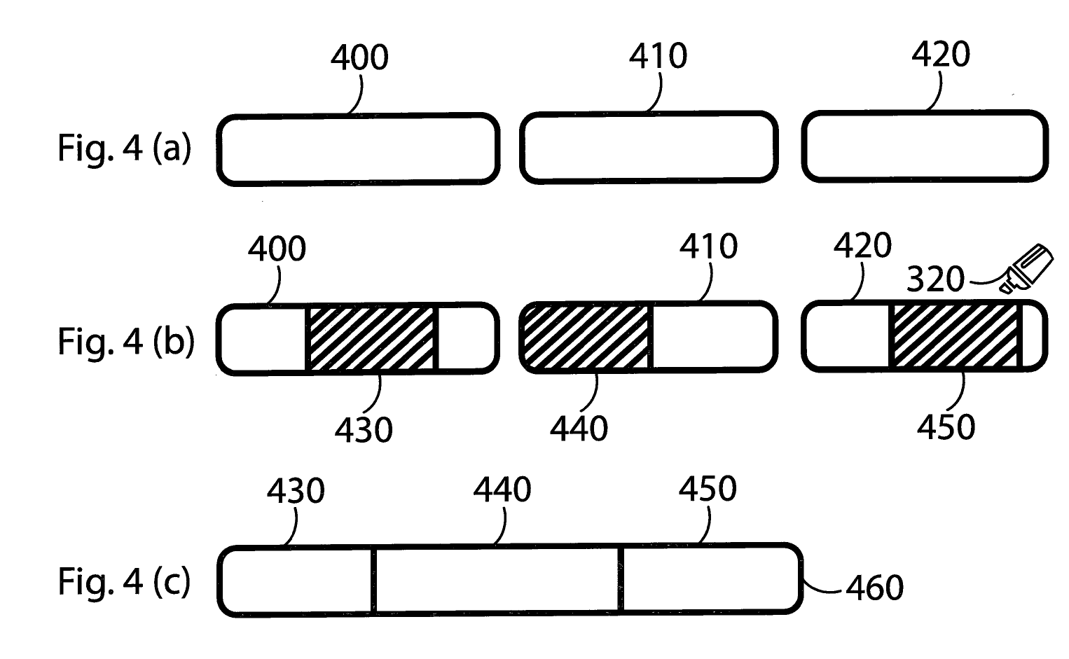

FIG. 4(b), and further show a long and a short video clip with respective highlighted portions,

FIGS. 7(a) to (c) are representative of one or more highlighting steps being carried out by a mouse attached to computer,

FIG. 8 shows a highlighted portion indicating a portion of the highlighted clip being played during selection, and

FIG. 9 shows several highlighted portions being joined to form a final clip.

### DETAILED DESCRIPTION

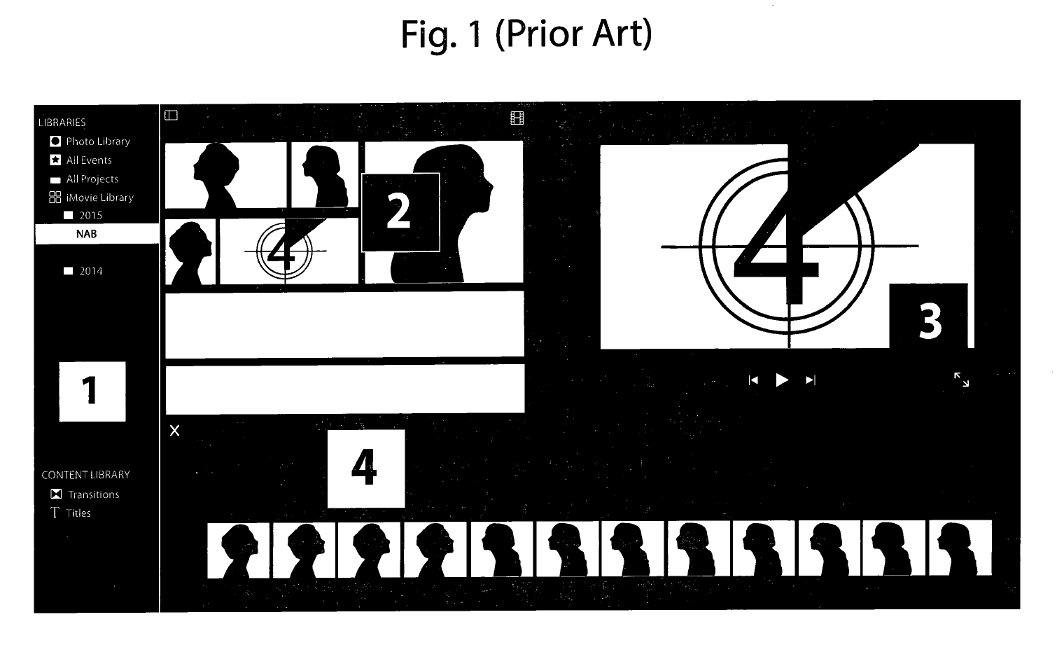

FIG. 1 shows an example of a conventional prior art video editing process. The area of Figure identified by the numeral ‘1’ shows a library format for storage of media such as videos, photographs, audio recordings or other suitable media, which have been captured on a device or a variety of devices, and a mechanism to access that media. The stored media may have been stored in the library by a variety of means, for example by importing, uploading or other conventional means.

The area of FIG. 1 identified by the numeral ‘2’ shows a preview of content selected in 1. Conventionally the selected content may be previewed only, for example no further interaction, such as playing the media or any other interaction, is possible. It is sometimes possible to select segments from the source content within this view.

The area of FIG. 1 identified by the numeral ‘3’ shows a different view that is available to the user. The different view is the edited content view. For example, when content has been edited and clips selected to make a desired compilation, the resulting compilation can be viewed and edited in this window.

The area of FIG. 1 identified by the numeral ‘4’ show the timeline followed in this conventional process. This shows the selection, re-ordering, and trimming of the compilation of clips.

Each of the areas 1 to 4 identified in FIG. 1 have multiple purposes, and users have many options available to them, for example they have the option to zoom into a view, or alter the view, or other options, as desired. For simple editing the process is too complex, and requires a significant knowledge of video editing to be suitable for, or accessible to, the casual, amateur or busy user.

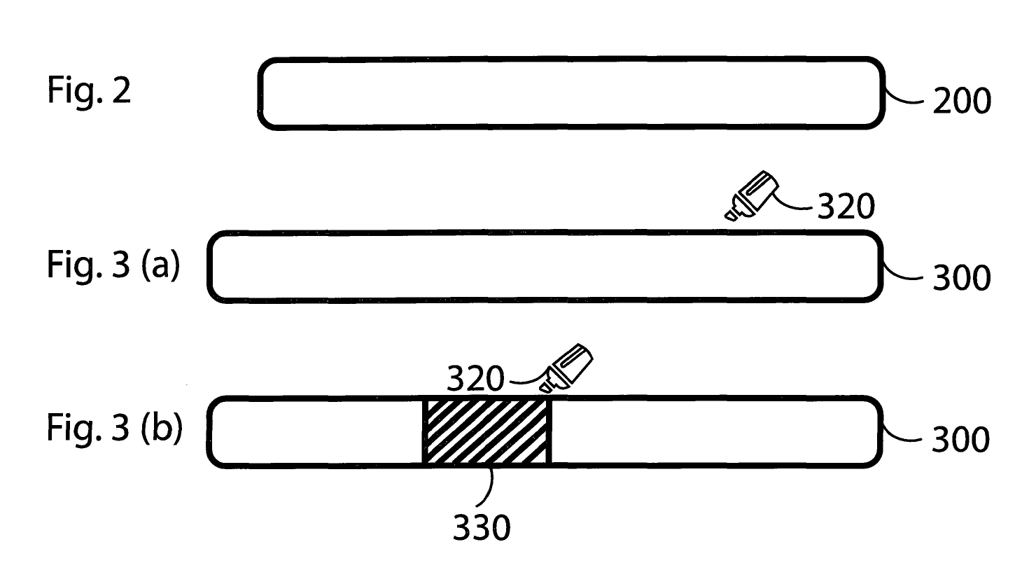

FIG. 2 shows an exemplary media clip 200. This media clip can be a video clip, an audio clip, or any other suitable, clip.

FIG. 3(a) shows the media clip of FIG. 2 with a ‘highlighter device’. For ease of explanation this is represented at this stage by a ‘highlighter pen’ 320.

FIG. 3(b) shows the media clip of FIG. 3(a) with the highlighter pen 320 highlighting a section 330 of the media clip.

FIG. 4(a) shows several media clips 400, 410, 420, in accordance with FIG. 3(a).

FIG. 4(b) shows each media clip with a highlighted section, respectively 430, 440, 450, and indicates that the highlighter pen 320 has highlighted the desired sections of the media clips for selection.

FIG. 4(c) shows a clip 460 resulting from combining the selected sections.

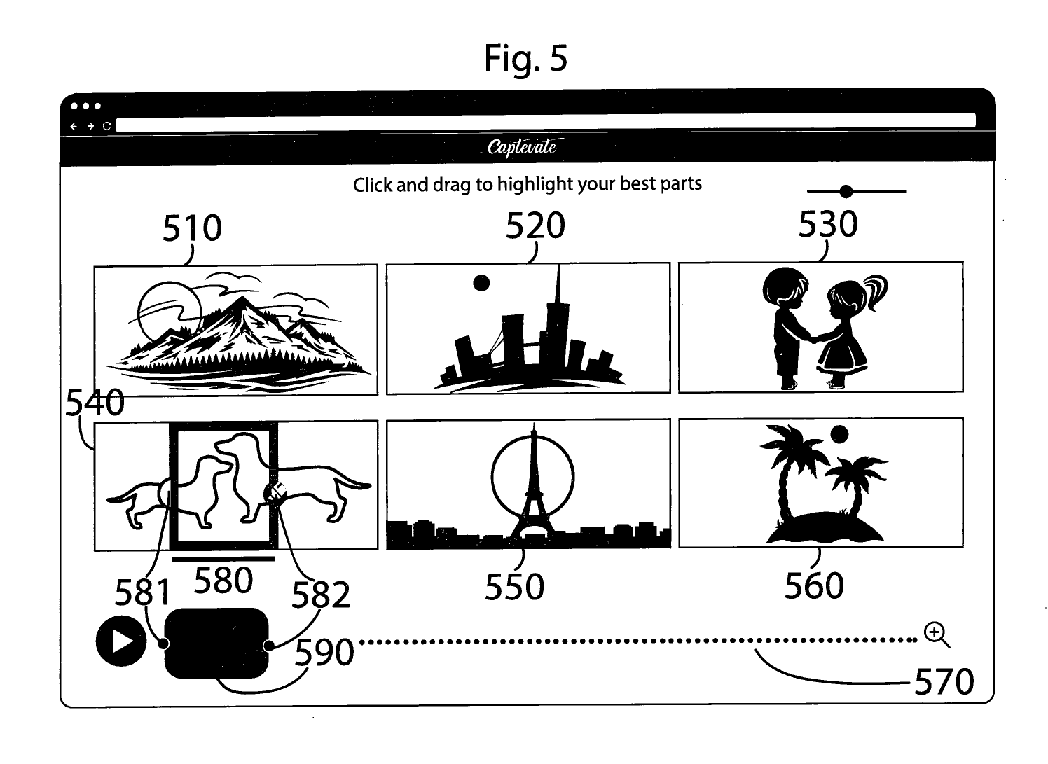

FIG. 5 shows several clips 510, 520, 530, 540, 550, 560 available to be reviewed. As such, each of the clips 510-560 provide for respective preview windows for a user to select portions for a final compilation. A user may decide that one particular clip is of interest, for example shown by clip 540 in FIG. 5, and select a portion of this clip to be incorporated into a final compilation clip. The portion of interest may be selected by highlighting, starting the highlighting at a first, initial position and ending the highlighting at a second, final position, so that the selected, highlighted portion includes all the media of interest between (and including) the first, initial and second, final positions. In particular the portion of interest of the current viewed frame of the original or source video clip, shown as clip 540 in FIG. 5, is highlighted, so that the start and end points in time of the selected section are represented by the start and end points in pixel position on the video frame being displayed.

To further indicate the portion of interest the selected portion may be allocated a colour so that the portion of interest is ‘tinted’. The colour allocated will be unique and distinct within each edited video, and in particular in respect of a compilation the colour allocated to each component clip will be unique and distinct within the compilation. A user will therefore be able to distinguish the selected portion (or portions) of any clip from the rest of the clip as the selected portion (or portions) is tinted whereas the rest of the clip is not. In addition a user will be able to distinguish between portions of the compilation; in particular a user will have the ability to identify and distinguish between portions of the compilation, and also between the respective source media for those portions. The selected portion of interest in FIG. 5 is indicated by reference numeral 580 on clip 540.

FIG. 5 further shows a timeline 570 of a compilation clip of which the selected section 580 forms a part. The timeline 570 shows in the present case that selected section 580 forms a first part 590 of the final compilation clip. As stated, it is contemplated that the selected clip portion 580 shown as item 590 on timeline 570, would be the same colour or hue as the tint applied to the selected portion 580 of the preview clip 540.

In accordance with the present invention the start and end points of a selected clip 580 may be edited from within the clip 540 and may also be edited on the timeline 570.

In particular, once in the timeline the selected portion or portions may be edited. For example, if the user wishes to increase or decrease the length of a selected portion of a clip, for example clip 580, this can be accomplished by dragging the circles 581, 582 at the edge of the clip: either in the timeline 570, or within the clip 540 from which the portion 580 has been selected.

It is contemplated that the timeline will not show the media but will provide a tinted representation of selected portions of clips with a length proportional to the duration of the respective selected clips. The tint may extend over the whole of the representation or may only cover a portion, for example cover a portion of the representation in a horizontal direction of the selected portion, but not extend fully in the vertical direction. Alternatively the representation of the clips on the timeline will include other means to show the dependence of the timeline on the duration of each clip.

The scale relied upon in the timeline may be varied, for example by the user or in other ways.

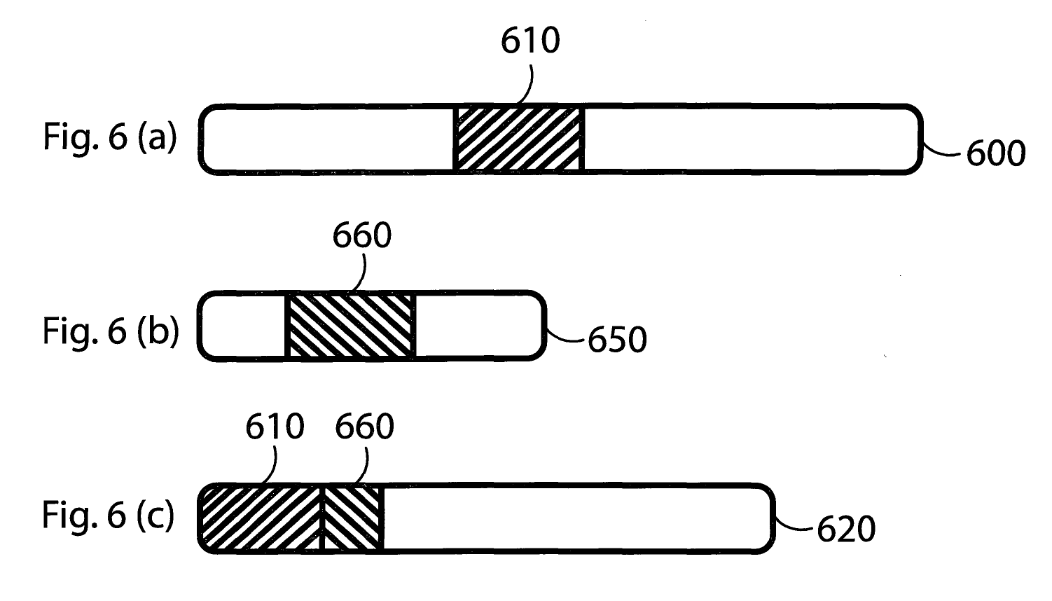

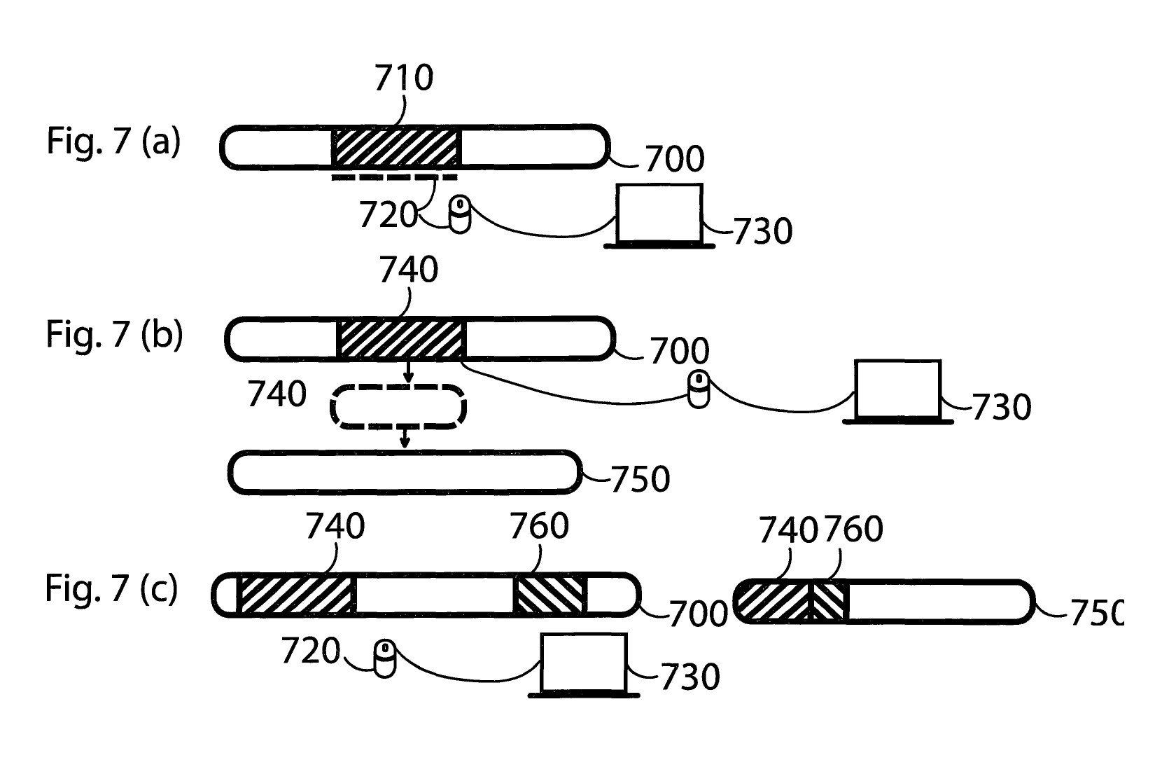

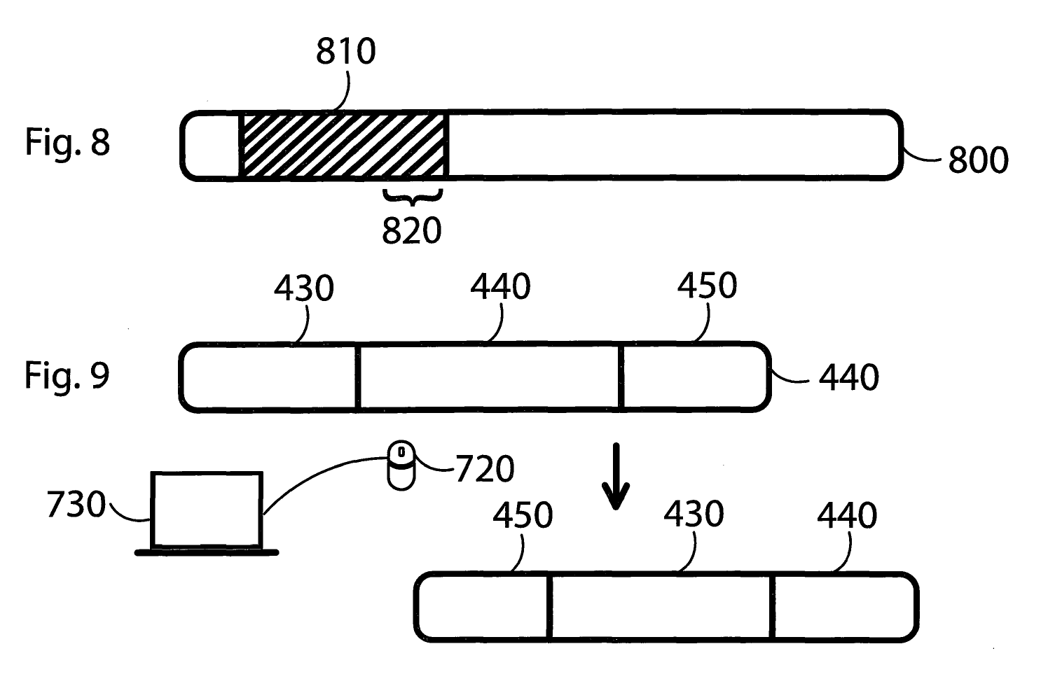

FIG. 6(a) shows an exemplary clip 600 with sub section 610 of the clip selected by the highlighting mechanism of the present invention. FIG. 6(b) shows a further exemplary clip 650 with a further subsection 660 selected by the highlighting mechanism of the present invention. Both selected portions may be placed in a timeline 620, in one implementation by the act of highlighting the clip. In accordance with the present invention it is contemplated that each selected portion is allocated a different colour which provides the selected portion to be tinted that colour on the timeline and also on the preview clip. The length of each preview clip 600, 650 is not relevant in accordance with the present invention. In particular clip 600 may be a long clip lasting for example several minutes whereas clip 650 may be a short clip lasting for example several seconds, however both 610 and 660 may be placed on the timeline in an order determined by the user. As stated, the length of each selected portion from the respective preview clips may be reflected by the length of the clip in the timeline.

The highlighter pen shown in FIGS. 2 to 5 may be an icon relied upon to assist a user. There are many ways in which a user may interact with an electronic device, and one of these ways includes a mouse in communication with a computer. FIG. 7 shows such a mouse 720, connected in this case to a computer 730, in which a user may roll the mouse 720 over a clip 700 and in accordance with conventional mechanisms click and drag the mouse to select a desired sub section 710 of the clip. Rolling the mouse over the clip may play the clip frames under or near the mouse position.

FIG. 7(a)-(c) show a mouse, connected to a computer, being used in accordance with the present invention to select a section 710 of a clip 700 to drag the selected section to timeline 750. In particular FIG. 7(a) shows the mouse being used conventionally to highlight a portion 710 of the preview clip 700. FIG. 7(b) shows the highlighted portion being moved to the timeline 750. FIG. 7(c) shows two sections 740 and 760 of the same clip 700 being selected by the mouse 720 for placement on the timeline 750.

It can be seen that allocating respective colour codes can be helpful where several clips are being edited, for example assigning respective colour codes to selected clips 430, 440, 450 in source clips 400, 410, 420 in FIGS. 4(a)-(c) will assist a user with carrying out further processing of the clips. It also allows the user to quickly associate the source of each timeline clip. For example, in situations where a user is required to use similar amounts of material from each source clip this colour coding would provide an extremely useful feature.

It is contemplated that the step of rolling the mouse over the clip without clicking will cause the media to be played, and the speed at which the media is played may depend on the speed with which the mouse is moved over the clip. This has the advantage that it allows the user to quickly find the area of the clip that is of most interest. For example, for a video clip the video frames will be displayed to the user at the speed at which the mouse is moved, unless it is within a narrow tolerance, in which case it may play at normal speed. As the mouse is under the control of the user, the user can dictate a speed with which he or she is comfortable. For an audio clip the sound will be provided at the speed at which the mouse is moved. Again, as the mouse is under the control of the user, the user dictates the speed with which he or she is comfortable. This equally applies to any other media clip.

In each case, once an area is highlighted, a portion of the clip close to the end of the selected, highlighted section is automatically played back to the user. This is shown in FIG. 8 in which section 810 of clip 800 has been highlighted for selection. Portion 820 at the end of the selected section 810 is automatically played when the section is highlighted. This allows the user to identify more clearly that the correct selection has been made. It is contemplated that for example the last two seconds of the media clip selected is played, although other periods are contemplated and fall within the scope of the invention. It is further contemplated that within the timeline each selected clip has a ‘bin’ button which allows a selected clip to be cancelled and/or deleted from the timeline.

Once the desired clips 400, 410, 420 have been viewed, the desired sections 430, 440, 450 highlighted and selections made, and a compilation 460 arrived at, a user may adapt the compilation and for example change the order of the clips in the compilation as shown in FIG. 8. This may be accomplished by dragging and dropping the clips around the compilation to arrive at a desired outcome. In addition, other editing functions would be available to the user, for example editing functions such as trimming, transitions and effects would be available to the user.

While discussion has been based on creating a timeline and a final compilation media from one or more source media or preview windows, the process may comprise an additional step. In particular the process may comprise creating and/or building a set of instructions for creation of the desired compilation. The instructions may be completed in the form of an Edit Decision List (EDL). The instructions may be manipulated by the editing operations for interpretation when the video is played, or rendered for publishing and distribution. This would be particularly advantageous as storage, transfer and manipulation of media requires much greater resources than storage, transfer and manipulation of instructions. It is contemplated that the subject media is readily available, for example being present in the cloud or suchlike, and so the interaction between a browser and a server would only need to send the instructions on how the server is to make the video from the media content it has access to, there would be no need to upload content each time an edit is changed.

In use, a user may take for example several videos on a mobile phone or other device, for example to record events at a wedding, party or other social occasion, and store them as media clips 200, 300, 410, 420, 430. 500, 600, 700. The user may wish to prepare footage to show to relatives or friends, or even just to retain for future reference or review. Any recording would necessarily include material that is incidental or irrelevant, or which the user would prefer not to form part of the final recording. In addition, the user may well decide to prepare a single video 460 including the best or preferred portions 430, 440, 450 of the several videos.

Conventionally the apparatus available for editing video or other media footage may not be readily available to the user, for example it may be expensive to buy, may not be adapted to be used on the recording device relied upon, and may be generally complex to use, requiring detailed understanding and experience. While it would be possible to arrange for a professional or experienced person to edit the clips to prepare a final compilation, this is not straightforward: it would take time and effort to explain the desired outcome which would in any event be filtered by the professional engaged to carry out the task, and would be expensive.

However, the present invention provides the user with a simple interface and mechanism to carry out this function. The user would initiate the invention to play each clip, and use a suitable pointing device to move over the clip and play it back at a speed comfortable to the user. As the user becomes aware that the portion of the clip of interest is near, the speed of playback may be slowed by slowing the movement of the pointing device over the clip. On ascertaining a section of interest the user may engage a highlighting function of the invention and highlight a section of the clip that appears to be of interest. On highlighting, the last bit of the highlighted section is played back to allow the user to confirm that the correct section of the clip has been selected.

On highlighting, the selected portion of the media clip may be allocated a colour code, and this colour code will be attached to the selected portion and also will be retained in the original media clip so that the user may easily link a selected portion of the clip to the originating, source video.

The selected media portion may be moved to a timeline.

The user may review several source clips and select sections of each clip. Each clip selected will have a colour code allocated thereto, both in the preview window and in the timeline; each colour code allocated being different to any other colour code allocated to ensure ease of use.

Once the user has completed the selection of the sections of clips, the selected portions will be present in a compilation on the colour coded timeline associated with the selected portions. A user may play the compilation of clips by pressing a play button provided. On review of the compilation the user may decide to change the order in which the clips have been provided, by dragging and dropping respective selected sections around the compilation, until the final compilation proves satisfactory. The final compilation may then be stored and distributed at will or may be enhanced further with additional editing features such as adding text, music, logos and/or stickers. This can be done in a separate part of the same tool, or can be done using other tools that are available to the user.

The result of using the invention is that source media is processed to make new media which is subsets of the original material. In the case of video media, for example, the new media will be video clips covering a consecutive range of frames. The resulting clips can then be further processed by adding effects, transitions, titles, music tracks or other features available in editing, such as video or audio editing.

The invention is not restricted to the details of the foregoing embodiment. For example the ways in which a user may interact with an electronic device may be by use of an implement such as a finger, or a pen, a mouse button on a lap top or tablet, or some other interactive device. While the media recorded has sometimes been referred to in relation to video clips, it is intended that the present invention relates to any kind of media clip, including audio, photographs, video or any other suitable media.

1. A system for editing at least one media clip comprising:
a highlighting circuit configured to highlight a selected portion of the media clip as represented on an electronic display;
a recording circuit configured to record data as a separate media clip defined in respect of said highlighted portion; and
a storage circuit configured to store said recorded data.

2. The system of claim 1 wherein the recording circuit is configured and arranged to record the data in a timeline.

3. The system of claim 1 wherein said highlighting indicates a start position of a selection of the media clip and an end position of the selection of the media clip, and wherein the recording circuit is configured to record the data for a portion of the media clip beginning at the start position and ending at the end position.

4. The system of claim 1, further including a computer circuit configured and arranged to respond to the action of moving a pointer over the media clip by playing the media clip near to a position or time represented by the position of the pointer.

5. The system of claim 3, wherein said start and end positions represent respective times of the start and of the end of the media clip selection.

6. The system of claim 5 wherein the start and end times relate to a timeline in the recorded data on which the highlighted portion is placed.

7. The system of claim 3 wherein the start and end positions represent respective pixel positions of the start and of the end of the media clip selection.

8. The system of claim 7 wherein the start and end pixel positions relate to a source clip or preview window from which the highlighted portion is selected.

9. The system of claim 1, further including a computer circuit configured and arranged to join said stored recorded data to other stored portions of recorded data to form a compilation media clip.

10. The system of claim 1, wherein the highlighting circuit is configured and arranged to allocate a color to the, or each, highlighted portion when displayed on the electronic display.

11. The system of claim 10 wherein the highlighting circuit is configured and arranged to tint the highlighted portion to the allocated color.

12. The system of claim 10 wherein the color allocated to each highlighted portion is different from the colors allocated to other ones of respective highlighted portions.

13. The system of claim 10 wherein the highlighting circuit is configured and arranged to apply the tint to the respective selected portion in a timeline displayed on the electronic display for the at least one media clip.

14. The system of claim 10 wherein the highlighting circuit is configured and arranged to apply the tint to a source clip of the selected portion.

15. The system of claim 9 wherein the computer circuit is configured and arranged to reorder an order of selected clips in the compilation media clip.

16. The system of claim 2 wherein the timeline has a predetermined size.

17. The system of claim 1 wherein the highlighting circuit is configured and arranged to, upon highlighting the selected portion, cause an end portion of said highlighted portion to be played back.

18. The system of claim 1 wherein said highlighting circuit is configured and arranged to display a pointer on the electronic display and to use the position of the displayed pointer to highlight the selected portion.

19. The system of claim 18 wherein the highlighting circuit is configured and arranged to move said pointer over the media clip represented on the electronic display at a speed dependent on a user speed selection.

20. The system of claim 18 wherein said highlighting circuit includes a computer mouse.

21. The system of claim 21 wherein said computer mouse provides for the highlighted portion to be selected by pointing and clicking.

22. The system of claim 1, further including a computer circuit configured and arranged to generate a series of instructions to operate on source media to generate a timeline of selected media clips.

23. The system of claim 22 wherein the series of instructions comprise an Edit Decision List.

24. The system of claim 23 wherein the Edit Decision List is adapted for interpretation to provide the timeline of selected media clips.

25. The system of claim 1, wherein the highlighting circuit, recording circuit and storage circuit are part of a computer circuit.

26. The system of claim 1 wherein:
the recording circuit and the storage circuit are remote from the highlighting circuit and the electronic display;
the electronic display is configured and arranged to display the represented media clip based on media clip data stored in the remote storage circuit and transmitted to the electronic display;
the highlighting circuit is configured and arranged to transmit instructions to the remote recording circuit, the instructions identifying a start and end point of the highlighted portion of the media clip as stored in the remote storage circuit; and
the recording circuit is configured and arranged to, in response to receiving the transmitted series of instructions, record the data and store the recorded data in the storage circuit.

27. An apparatus comprising:
a storage circuit configured and arranged to store recorded media clip data including video data for a plurality of separate media clips; and
a computer circuit configured and arranged with the storage circuit to edit media clips and produce video including combined aspects of the media clips by:
cause concurrent display of visual representations of media clip data for the plurality of separate media clips on an electronic display;
for each visual representation of a media clip, highlight a portion of the visual representation of the media clip in response to user inputs provided relative to the display of the visual representation the media clip; and
producing the video by combining stored recorded media clip data from respective ones of the plurality of separate media clips corresponding to the highlighted portions of the visual representations of the media clips.

28. The apparatus of claim 27, wherein the computer circuit is configured and arranged to, for each of the media clips:
display and move a position pointer over the display of the visual representation of each media clip in response to user inputs;
playback video corresponding to the portion of the media clip over which the position pointer is located, for review by the user providing the user inputs, at a speed corresponding to a speed at which the user moves the pointer over the displayed visual representation of the media clip;
record, in response to the user providing a user input selection at a portion of the visual representation of the video clip over which the pointer is positioned, a start position for the highlighted portion;
record, in response to the user providing a user input selection at a portion of the visual representation of the video clip over which the pointer is positioned, a stop position for the highlighted portion; and
highlight the portion of the visual representation of the media clip by highlighting a continuous portion of the video clip between the start position and the stop position.
